(19) United States
(12) Patent Application Publication
(10) Pub. No.: US 2024/0181541 A1
(43) Pub. Date: Jun. 6, 2024

(54) DRILL JIG SYSTEM

(71) Applicant: The Boeing Company, Chicago, IL (US)

(72) Inventor: Corey Roy Cassell, Enumclaw, WA (US)

(21) Appl. No.: 18/061,769

(22) Filed: Dec. 5, 2022

(51) Int. Cl. B23B 47/28; B23B 35/00

(52) U.S. Cl. CPC B23B 47/287; B23B 35/00

(57) ABSTRACT

A drill jig system and methods of using the drill jig system for drilling a hole in a workpiece having a pilot hole formed therein are disclosed. According to an example, the drill jig system comprises a clamping device including a first clamp member and a second clamp member operable to clamp onto opposing sides of a workpiece. The drill jig system further comprises a drill guide device that defines a drilling axis. The drill jig system further comprises an alignment device removably received within a first opening in the first clamp member or the second clamp member. The alignment device includes a spring-biased alignment element that is biased toward the workpiece and into the pilot hole to align the drilling axis of the drill guide device with the pilot hole.

### FIELD

An invention of the present disclosure relates generally to a drill jig system for drilling a hole in a workpiece in alignment with a pilot hole.

### BACKGROUND

Some manufacturing processes involve drilling holes in a workpiece within regions of limited access for tooling. As an example, a workpiece may include physical features that offer insufficient clearance for some tools to perform drilling operations at prescribed locations and orientations. Computer numerical control (CNC) equipment, for example, may be unable to perform drilling operations within such regions of limited access without the use of specialized CNC procedures and equipment. The development, acquisition, and use of specialized procedures and equipment may consume significant resources in terms of time, cost, and materials. Where the quantity of production units being manufactured is sufficiently low, the development, acquisition, and use of specialized techniques and equipment may be prohibitive.

### SUMMARY

A drill jig system for drilling a hole in a workpiece having a pilot hole formed therein is disclosed. According to an example, the drill jig system comprises a clamping device including a first clamp member and a second clamp member operable to clamp onto opposing sides of a workpiece. The drill jig system further comprises a drill guide device that defines a drilling axis. The drill jig system further comprises an alignment device removably received within a first opening formed within the first clamp member or the second clamp member. The alignment device includes a spring-biased alignment element that is biased toward the workpiece and into the pilot hole to align the drilling axis of the drill guide device with the pilot hole. In a first example, the drill guide device is removably received by the first opening following removal of the alignment device from the first opening. In a second example, the drill guide device is removably received by a second opening in another of the first clamp member or the second clamp member.

Methods of drilling a hole in a workpiece having a pilot hole formed therein using a drill jig system are disclosed. A first example method comprises positioning a first clamp member and a second clamp member of a clamping device of the drill jig system on opposing sides of the workpiece. The first clamp member or the second clamp member has a first opening formed therein that removably receives an alignment device of the drill jig system. The alignment device includes a spring-biased alignment element that is biased toward the workpiece and into the pilot hole. The method further comprises clamping the clamping device to the opposing sides of the workpiece via the first clamp member and the second clamp member while the spring-biased alignment element remains biased into the pilot hole. The method further comprises, while the clamping device remains clamped to the opposing sides of the workpiece, removing the alignment device from the first opening and inserting a drill guide device of the drill jig system into the first opening that removably receives the drill guide device to align a drilling axis of the drill guide device with the pilot hole. The method further comprises, while the clamping device remains clamped to the opposing sides of the workpiece and the drill guide device is received by the first opening, drilling the hole in the workpiece along the drilling axis through the drill guide device.

A second example method comprises positioning a first clamp member and a second clamp member of a clamping device of the drill jig system on opposing sides of the workpiece. The first clamp member has a first opening formed therein that removably receives an alignment device of the drill jig system that includes a spring-biased alignment element that is biased toward the workpiece and into the pilot hole. The second clamp member has a second opening formed therein that removably receives a drill guide device of the drill jig system. The method further comprises clamping the clamping device to the opposing sides of the workpiece via the first clamp member and the second clamp member while the spring-biased alignment element remains biased into the pilot hole. The method further comprises, while the clamping device remains clamped to the opposing sides of the workpiece and the drill guide device is received by the second opening, drilling the hole in the workpiece through the drill guide device along a drilling axis of the drill guide device.

### BRIEF DESCRIPTION OF THE DRAWINGS

FIG. 1 depicts an example drill jig system for drilling a hole in a workpiece having a pilot hole formed therein.

FIG. 2 depicts an example of the drill jig system of FIG. 1 being used to drill holes in a workpiece.

FIG. 3 is a flow diagram depicting a first example method of drilling a hole in a workpiece having a pilot hole formed therein using a drill jig system.

FIGS. 4A, 4B, 4C, 4D, and 4E depict section views of the drill jig system of FIG. 1 being used to drill a hole in the workpiece of FIG. 2 using the method of FIG. 3.

FIG. 5 is a flow diagram depicting a second example method of drilling a hole in a workpiece having a pilot hole formed therein using a drill jig system.

FIGS. 6A and 6B depict section views of the drill jig system of FIG. 1 being used to drill a hole in the workpiece of FIG. 2 using the method of FIG. 5.

### DETAILED DESCRIPTION

As briefly introduced above, some manufacturing processes involve drilling holes in a workpiece within regions of limited access for tooling. As an example, a workpiece may include physical features that offer insufficient clearance for some tools to perform drilling operations at prescribed locations and orientations. Computer numerical control (CNC) equipment, for example, may be unable to perform drilling operations within such regions of limited access without the use of specialized CNC procedures and equipment. The development, acquisition, and use of specialized procedures and equipment may consume significant resources in terms of time, cost, and materials. Where the quantity of production units being manufactured is sufficiently low, the development, acquisition, and use of specialized techniques and equipment may be prohibitive.

A drill jig system and methods of use are disclosed that have the potential to address the above issues. The drill jig system includes a clamping device, an alignment device that can be removably received within an opening formed in the clamping device, and a drill guide that can be removably received within the same opening as the alignment device or within a second opening formed in an opposing side of the clamping device. A CNC machine or other suitable technique can be used to form a pilot hole (e.g., a divot) within a workpiece at a prescribed location where a hole is to be subsequently drilled in the workpiece. The alignment device includes a spring-biased alignment element that can be used to align the drill jig system with the pilot hole by biasing the alignment element toward the workpiece and into the pilot hole. The alignment element can provide a detent function when biased into the pilot hole for maintaining alignment while the clamping device is being clamped to the workpiece.

While the clamping device remains clamped to the workpiece in alignment with the pilot hole, a hole can be drilled in the workpiece along a drilling axis of the drill guide in alignment with the pilot hole. As an example, the hole can be drilled using a hand-operated 90-degree drill motor or other suitable drilling device.

The alignment device can be removed from the opening formed in the clamping device prior to drilling to enable the hole to be drilled in the workpiece from the same side as the pilot hole without obstructing the drill bit. Removal of the alignment device prior to drilling can also enable the same opening formed in the clamping device to be interchangeably used for the alignment device and the drill guide device. The use of a second opening to removably receive the drill guide device on an opposing side of the clamping device from the alignment device can enable the hole to be drilled from an opposite side of the workpiece from the pilot hole. In this configuration, removal of the alignment device prior to drilling enables a through hole to be drilled through the workpiece without obstructing the drill bit. Accordingly, the disclosed drill jig system can support the drilling of both through holes and blind holes from either side of the workpiece in alignment with the pilot hole.

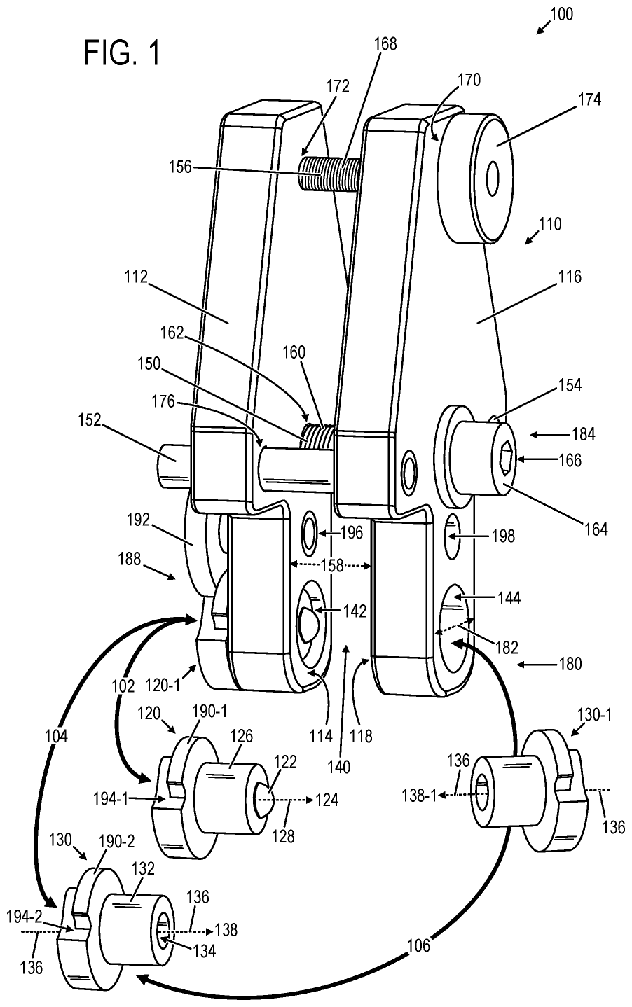

FIG. 1 shows an example drill jig system 100 of the present disclosure for drilling a hole in a workpiece having a pilot hole formed therein. Drill jig system 100 comprises a clamping device 110, an alignment device 120, and a drill guide device 130, examples of which are depicted in FIG. 1. As briefly introduced above, alignment device 120 can be used to align the drill jig system with the pilot hole, clamping device 110 can be clamped to opposing sides of the workpiece to maintain the alignment, and drill guide device 130 can be used to drill a hole along a drilling axis in alignment with the pilot hole while the clamping device remains clamped to the workpiece.

Clamping device 110 is operable to clamp onto opposing sides of a workpiece. Clamping device 110 includes a first clamp member 112 having a first clamp surface 114 and a second clamp member 116 having a second clamp surface 118 that opposes the first clamp surface. First clamp surface 114 and second clamp surface 118 define a clamping region 140 that accommodates the workpiece to which clamping device 110 is to be clamped.

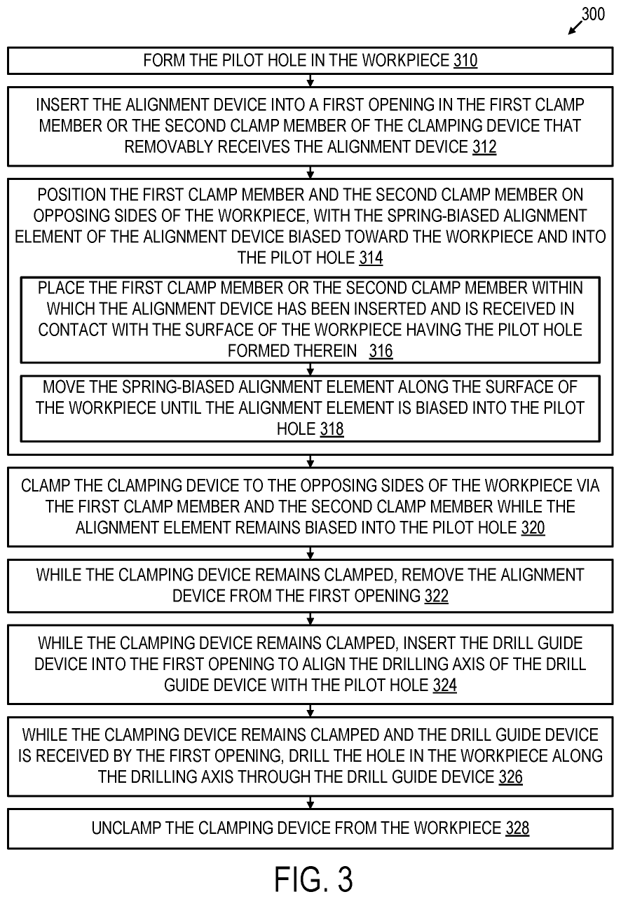

First clamp member 112 has a first opening 142 formed therein that can removably receive alignment device 120, as depicted in FIG. 1 at 120-1. In at least some examples, first opening 142 can removably receive drill guide device 130 to enable a hole to be drilled from the same side of the workpiece as the pilot hole, as described in further detail with reference to FIG. 3. For example, arrows 102 and 104 in FIG. 1 respectively represent the removal and insertion of alignment device 120 and drill guide device 130 in relation to first opening 142.

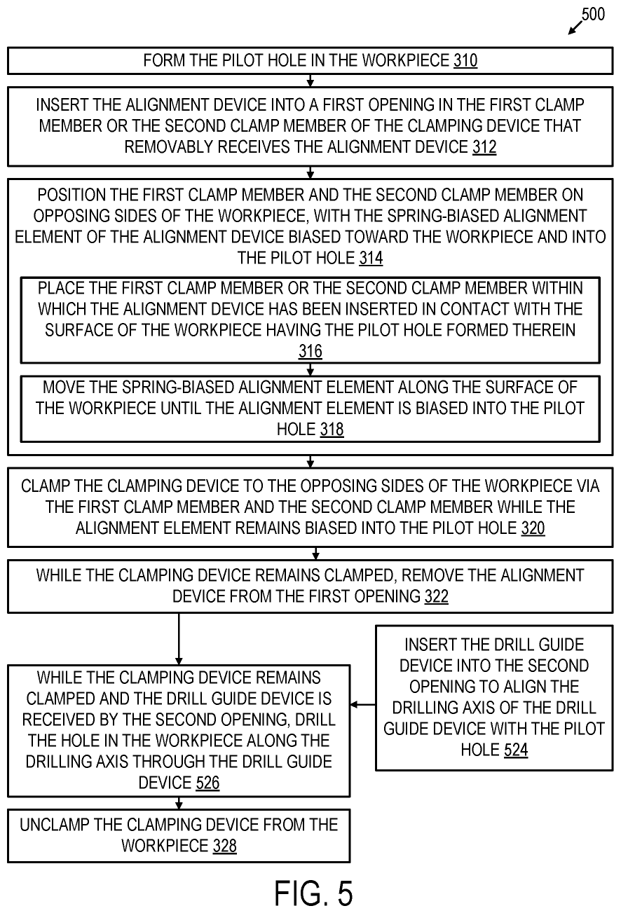

In at least some examples, second clamp member 116 can have a second opening 144 formed therein that opposes first opening 142 and that can removably receive drill guide device 130 to enable a hole to be drilled from the opposite side of the workpiece from the pilot hole, as described in further detail with reference to FIG. 5. For example, arrow 106 in FIG. 1 represents the removal and insertion of drill guide device 130 in relation to second opening 144. Furthermore, in at least some examples, second opening 144 can removably receive alignment device 120.

Alignment device 120 includes a spring-biased alignment element 122 that is biased outward from the alignment device by a biasing force having a bias direction 124. As an example, alignment device 120 is a ball-spring plunger, and alignment element 122 takes the form of a ball of the ball-spring plunger. In this example, a spring of the ball-spring plunger that provides the biasing force can be housed within a body portion 126 of the alignment device. The pilot hole formed in the workpiece can be sized and shaped to accommodate the ball or other suitable shape of alignment element 122.

While alignment device 120 is received by first opening 142 of first clamp member 112 (as shown in FIG. 1), alignment element 122 defines an alignment axis 128 of the drill jig system, and the alignment element projects outward beyond a plane formed by first clamp surface 114 toward second clamp surface 118. In this configuration, alignment element 122 is biased toward the workpiece in bias direction 124. By placing first clamp surface 114 in contact with a surface of the workpiece within which the pilot hole is formed, alignment element 122 can be depressed in a direction opposite bias direction 124 while the alignment element is not aligned with the pilot hole. Clamping device 110 can be moved relative to the workpiece while maintaining contact between first clamp surface 114 and the workpiece until alignment element 122 is aligned with the pilot hole. Upon achieving alignment of alignment element 122 with the pilot hole, the alignment element is biased into the pilot hole in bias direction 124 by the biasing force provided by alignment device 120. While alignment element 122 remains biased into the pilot hole, the alignment element inhibits in-plane translation of clamp member 112 relative to the workpiece, enabling alignment to be maintained while clamping device 110 is being clamped to opposing sides of the workpiece.

Drill guide device 130 is depicted in FIG. 1 at a first orientation by which the drill guide device can be received by first opening 142, and is further depicted at 130-1 at a second orientation by which the drill guide device can be received by second opening 144. Drill guide device 130 includes a drill bushing 132 having a bore 134 that accommodates a drill bit and that defines a drilling axis 136. Arrow 138 in FIG. 1 represents a drilling direction of drill guide device 130 through bore 134 along drilling axis 136 by which a drill bit can be used to drill a hole in the workpiece. Arrow 138-1 in FIG. 1 represents an opposite drilling direction of the drill guide device at the second orientation depicted at 130-1.

Alignment of drill guide device 130 with the pilot hole is achieved while the drill guide device is received by first opening 142 or by second opening 144 following clamping of clamping device 110 to the workpiece. Additionally, while clamping device 110 remains clamped to the workpiece, in either orientation of drill guide device 130, drilling axis 136 is colinear with alignment axis 128 at the time that alignment of alignment element 122 with the pilot hole was achieved. Thus, alignment of alignment element 122 with the pilot hole is imparted to alignment of drill guide device 130 with the pilot hole. This feature enables alignment of drilling axis 136 with the pilot hole to be maintained even after alignment device 120 is removed from clamping device 110.

In at least some examples, drill guide device 130 is one of a plurality of drill guide devices that each include a drill bushing having a bore of a different diameter than each other drill guide device of the plurality of drill guide devices to accommodate a variety of different drill bit diameters. Drill jig system 100 can further include the plurality of drill guide devices of different bore diameters, which can be removably received by first opening 142 and second opening 144 as previously described with reference to drill guide device 130.

In at least some examples, drill jig system 100 includes a locking mechanism 188 that is operable to retain alignment device 120 within first opening 142. As an example of locking mechanism 188, alignment device 120 further includes a rotational latch 190-1 that engages with a retaining flange 192 mounted to first clamp member 112 to retain the alignment device within first opening 142. Rotational latch 190-1 defines a semi-annular flange having a channel 194-1 formed therein that enables alignment device 120 to be withdrawn from first opening 142 by rotating channel 194-1 to a position in which retaining flange 192 does not interfere with rotational latch 190-1. It will be understood that other suitable locking mechanisms can be used to retain alignment device 120 within first opening 142.

In at least some examples, drill guide device 130 can include a rotational latch 190-2 having a similar shape as rotational latch 190-1 that likewise engages with retaining flange 192 to retain the drill guide device within first opening 142. Rotational latch 190-2 similarly defines a semi-annular flange having a channel 194-2 formed therein that enables drill guide device 130 to be withdrawn from first opening 142 by rotating channel 194-2 to a position in which retaining flange 192 does not interfere with rotational latch 190-2. In other examples, rotational latch 190-2 is omitted from drill guide device 130, as the drilling direction through the drill guide device can serve to retain the drill guide device within first opening 142.

Retaining flange 192 can be mounted within an opening 196 formed within first clamp member 112. In at least some examples, retaining flange 192 can be removed from opening 196 and mounted within an opening 198 formed within second clamp member 116. Furthermore, in at least some examples, a second instance of retaining flange 192 can be mounted within opening 198 to retain alignment device 120 or drill guide device 130 on either side of the workpiece.

Clamping device 110 further includes spanning members 150, 152, 154, and 156 that span first clamp member 112 and second clamp member 116 to couple and/or support first clamp member 112 and second clamp member 116 in a configuration in which first clamp surface 114 opposes second clamp surface 118. One or more of spanning members 150, 152, 154, and 156 take the form of an adjustable spanning member that are operable to vary a clamp distance 158 between first clamp surface 114 and second clamp surface 118.

Spanning member 150 is an example of an adjustable spanning member that can be used to adjust clamp distance 158 and provide a clamping force on the workpiece residing within clamping region 140 between first clamp surface 114 and second clamp surface 118. In this example, spanning member 150 is rotatably mounted to second clamp member 116 and includes a threaded shaft 160 that engages with corresponding threads of a receptacle 162 formed within first clamp member 112. Alternatively, spanning member 150 can be rotatably mounted to first clamp member 112, and threaded shaft 160 can engage with corresponding threads of a receptacle formed within second clamp member 116.

Spanning member 150 can be rotated to increase or decrease clamp distance 158 between first clamp surface 112 and second clamp surface 116, thereby increasing or decreasing the clamping force provided by clamping device 110 on the workpiece. A head 164 of spanning member 150, in this example, has a tool interface 166 that accommodates a tool (e.g., a hex key or other suitable tool) to be used to rotate spanning member 150 to achieve a desired level of clamping force and clamp distance 158. Head 164 can include other suitable structures to accommodate other types of tools to enable spanning member 150 to be rotated. As another example, head 164 can instead take the form of a knob or lever that enables spanning member 150 to be rotated by hand.

Spanning member 156 is another example of an adjustable spanning member that can be used to adjust clamp distance 158 and provide a clamping force on the workpiece residing within clamping region 140 between first clamp surface 114 and second clamp surface 118. Spanning member 156 spans first clamp member 112 and second clamp member 116 on an opposite side of spanning member 150 from a nose end 180 of clamping device 110. In this example, spanning member 156 includes a threaded shaft 168 that engages with corresponding threads of a receptacle 170 formed within second clamp member 116. An opposing end of threaded shaft 168 contacts first clamp surface 114 of first clamp member 112 as indicated at 172. Alternatively, receptacle 170 can be formed within first clamp member 112, and the opposing end of threaded shaft 168 can instead contact second clamp surface 118.

Spanning member 156 can be rotated to increase or decrease clamp distance 158 between first clamp surface 112 and second clamp surface 116, thereby increasing or decreasing the clamping force provided by clamping device 110 on the workpiece. A head 174 of spanning member 156, in this example, takes the form of a knob that can be used to rotate (e.g., by hand) spanning member 156 to achieve a desired level of clamping force and clamp distance 158. Head 156 can include other suitable structures including a lever or a tool interface to accommodate a tool to enable spanning member 156 to be rotated.

As described above, in the example of FIG. 1, head 174 of spanning member 156 takes the form of a knob that enables an initial clamping force to be provided by hand, and head 165 of spanning member 150 includes tool interface 166 that enables an additional clamping force to be provided by use of a tool to further increase the total clamping force provided by clamping device 110 on the workpiece.

Spanning members 152 and 154 located on opposing sides of spanning member 150 serve as guides that contribute to maintaining alignment of first clamp member 112 and second clamp member 116. In this example, spanning members 152 and 154 are each mounted to second clamp member 116, and each pass through a corresponding opening formed within first clamp member 112. For example, as shown in FIG. 1, spanning member 152 passes through an opening 176 formed within first clamp member 112. As clamping distance 158 is varied by rotation of spanning members 150 and/or 156, first clamp member 112 translates along spanning members 152 and 154 relative to second clamp member 114. Alternatively, spanning members 152 and 154 can each be mounted to first clamp member 112, and each pass through a corresponding opening formed within second clamp member 116.

In the example of FIG. 1, first opening 142 of first clamp member 112 and second opening 144 of second clamp member 116 are aligned with each other at nose end 180 of clamping device 110. In at least some examples, first clamp member 112 defines an outer profile of first clamp surface 114 that tapers toward nose end 180, and second clamp member 116 defines an outer profile of second clamp surface 118 that similarly tapers toward nose end 180. As an example, first clamp member 112 and second clamp member 116 each have a narrower width dimension 182 at nose end 180 as compared to a central region 184 of the clamping device where spanning members 150, 152, and 154 are located. For example, first opening 142 is formed within first clamp member 112 and second opening 144 is formed within second clamp member 116 at a location that is closer to nose end 180 than each of the one or more spanning members. This narrower width dimension 182 enables alignment device 120 and drill guide device 130 received within openings 142 or 144 near nose end 180 to access corners or other regions of limited access of a workpiece for alignment and drilling, while the greater width dimension of central region 184 offers increased lateral support of clamping device 110 via spanning members 150, 152, and 154.

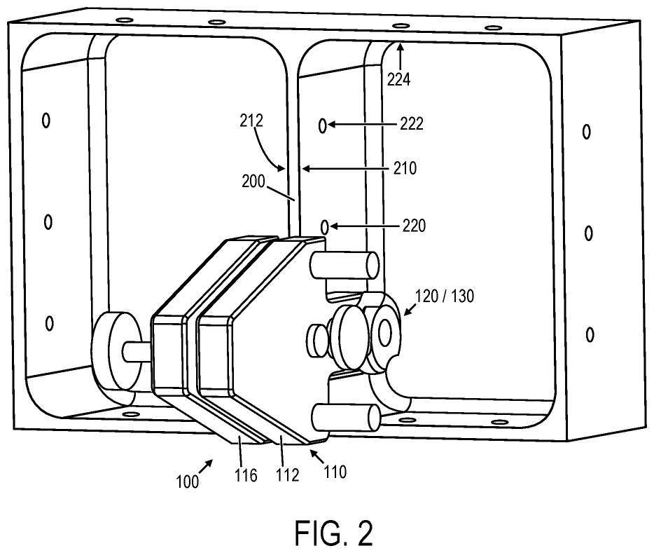

FIG. 2 depicts an example of drill jig system 100 of FIG. 1 being used to drill holes in a workpiece 200. The workpiece is shown to have a physical configuration that includes some surfaces, for example an interior wall defined by surfaces 210 and 212, that may be difficult to drill due to insufficient clearance for some drilling equipment, such as CNC equipment, to perform a drilling operation. In this example, clamping device 110 is clamped to opposing sides of workpiece 200 formed by a first surface 210 and a second surface 212 via first clamp member 212 and second clamp member 116. Alignment device 120 and drill guide device 130 can be interchangeably received by first opening 142, as shown in FIG. 1. Example holes drilled in workpiece 200 using drill jig system 100 are depicted at 220, 222, and 224 at various locations of the workpiece.

FIG. 3 is a flow diagram depicting a first example method 300 of drilling a hole in a workpiece having a pilot hole formed therein using a drill jig system. In method 300, the hole is drilled from the same side of the workpiece as the pilot hole. Drill jig system 100 of FIG. 1 is one example of a drill jig system that can be used to perform method 300. Accordingly, the drill jig system used to perform method 300 can include a clamping device (e.g., 110), an alignment device (e.g., 120), and a drill guide device (e.g., 130), as previously described with reference to FIG. 1.

At 310, the method can include forming a pilot hole in the workpiece. In at least some examples, a CNC machine can be used to form the pilot hole in the workpiece at a prescribed location. As an example, the pilot hole can be formed by a material removal process, such as cutting, grinding, drilling, etc. using suitable tooling. For example, a ball-nose cutter can be fit to a CNC end mill, and the ball-nose cutter can be positioned at an orientation that fits within the restricted space. As another example, the pilot hole can be formed at the time of casting, molding, or additive manufacture of the workpiece.

The pilot hole can take the form of a blind hole, such as a divot, having a depth that is less than the depth of the hole to be drilled. The pilot hole can be formed to have a shape (e.g., diameter and/or depth) that accommodates an alignment element (e.g., 122) of the alignment device of the drill jig system while also reducing or minimizing over-sizing the pilot hole dimensions to thereby achieve a suitable level of alignment precision using the alignment element. In an example where the alignment element takes the form of a ball, the pilot hole can take the form of a semi-spherical divot that accommodates a portion of the ball at a depth sufficient to provide a suitable detent function for the alignment device. As an example, the semi-spherical divot can be sized to accommodate half of the ball or other suitable depth. It will be understood that other suitable pilot hole shapes can be used to accommodate alignment elements of other shapes, including non-spherical alignment elements.

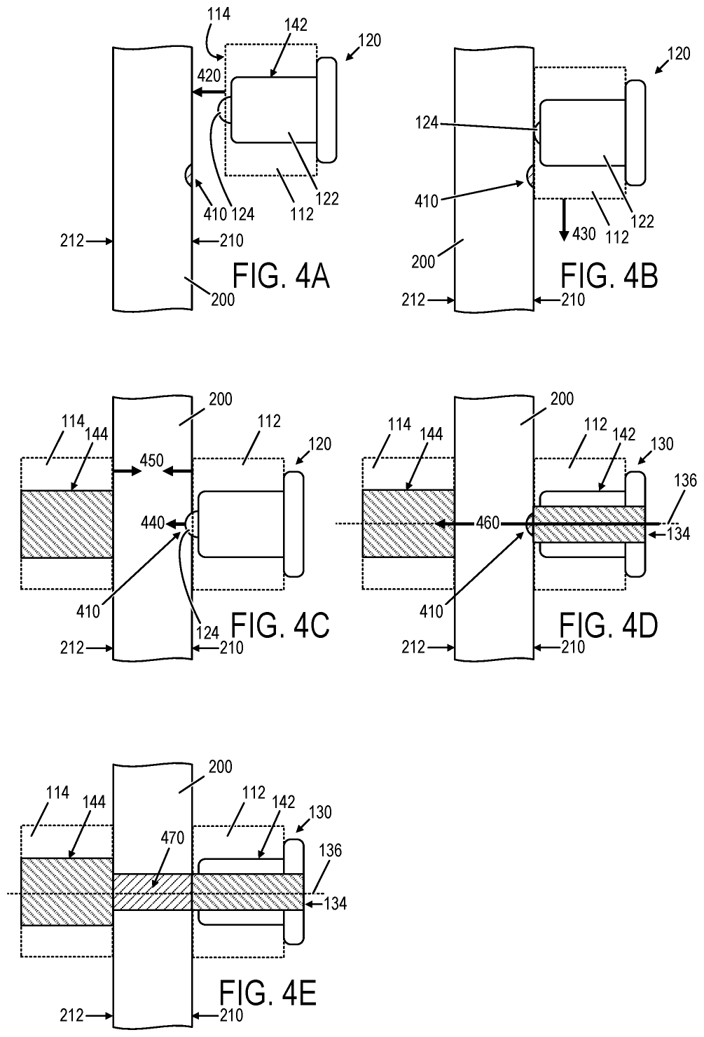

Referring also to FIG. 4A, a section of workpiece 200 of FIG. 2 is depicted having a pilot hole 410 formed therein on first side 210 of the workpiece. In this example, pilot hole 410 is a blind hole in the form of a divot having a semi-spherical shape.

Referring again to FIG. 3, at 312, the method can include inserting the alignment device into a first opening in a first clamp member or a second clamp member of the clamping device that removably receives the alignment device. Referring to drill jig system 100 of FIG. 1, alignment device 120 can be inserted into first opening 142 formed within first clamp member 112, or alignment device 120 can be inserted into second opening 144 formed within second clamp member 116. As previously described with reference to FIG. 1, the alignment device can be retained within the first opening or the second opening by rotating the alignment device to engage rotational latch 190-1 with retaining flange 192. For purposes of clarity, the remaining operations described with reference to method 300 assumes that the alignment device is inserted into the first opening (e.g., 142) of the first clamp member (e.g., 112).

In FIG. 4A, for example, alignment device 120 is depicted being received within first opening 142 of first clamp member 112, as shown in a section view.

Referring again to FIG. 3, at 314, the method can include positioning the first clamp member and the second clamp member of the clamping device on opposing sides of the workpiece, with the spring-biased alignment element of the alignment device biased toward the workpiece and into the pilot hole. Positioning the first clamp member and the second clamp member can include, at 316, placing the first clamp member or the second clamp member within which the alignment device has been inserted against the surface of the workpiece having the pilot hole formed therein. At 318, positioning the first clamp member and the second clamp member can include moving the spring-biased alignment element along the workpiece until the alignment element is biased into the pilot hole.

In FIG. 4A, for example, first clamp surface 114 of first clamp member 112 spring-biased alignment element 124 is placed against surface 210 of workpiece 200, as indicated by arrow 420.

In FIG. 4B, for example, spring-biased alignment element 124 is biased toward first surface 210 of workpiece 200 and is depressed in a direction that opposes the biasing force due to contact of the alignment element and first clamp surface 114 with first surface 210 of workpiece 200. Also within FIG. 4B, spring-biased alignment element 124 is moved along first surface 210 of workpiece 200, as indicated by arrow 430, until the alignment element is biased into pilot hole 410.

In FIG. 4C, spring-biased alignment element 124 is biased into pilot hole 410, as indicated by arrow 440. Spring-biased alignment element 124 provides a detent function while biased into pilot hole 410 that inhibits in-plane translation of first clamp member 112 along first surface 210 of workpiece 200.

Referring again to FIG. 3, at 320, the method can include clamping the clamping device to the opposing sides of the workpiece via the first clamp member and the second clamp member while the spring-biased alignment element remains biased into the pilot hole.

In FIG. 4C, for example, first clamp member 112 and second clamp member 114 are clamped to first surface 210 and second surface 212 forming opposing sides of workpiece 200, as indicated by arrows 450.

Referring again to FIG. 3, at 322, the method can include, while the clamping device remains clamped to the opposing sides of the workpiece, removing the alignment device from the first opening. At 324, the method can include, while the clamping device remains clamped to the opposing sides of the workpiece, inserting the drill guide device of the drill jig system into the first opening that removably receives the drill guide device to align a drilling axis of the drill guide device with the pilot hole.

In FIG. 4D, for example, alignment device 120 has been removed from the first opening of first clamp member 112, and drill guide device 130 has been inserted into the first opening of the first clamp member. Within FIG. 4D, drilling axis 136 of bore 134 of drill guide device 130 is aligned with pilot hole 410.

Referring again to FIG. 3, at 326, the method can include, while the clamping device remains clamped to the workpiece and the drill guide device is inserted into and received by the first opening, drilling the hole in the workpiece along the drilling axis through the drill guide device. In this example, the hole can be drilled using a drill bit progressing through the workpiece from the side of workpiece within which the pilot hole is formed toward the opposing side of the workpiece.

In FIG. 4D, for example, drilling can be performed along drilling axis 136 through drill guide device 130, in the direction indicated by arrow 460. In this example, drilling progresses from the side of the workpiece within which pilot hole 410 is formed (e.g., first surface 210) toward the opposing side of the workpiece (e.g., second surface 212). Furthermore, in this example, second opening 144 can provide clearance for a drill bit to drill a through hole in workpiece 200.

FIG. 4E depicts a hole 470 that was drilled in workpiece 200 along drilling axis 136 through drill guide device 130. In this example, hole 470 is a through hole drilled through workpiece 200 from first side 210 to second side 212. Hole 470 can instead take the form of a blind hole that is drilled to a prescribed depth in workpiece 200 from first side 210.

Referring again to FIG. 3, at 328, the method can include unclamping the clamping device from the workpiece.

FIG. 5 is a flow diagram depicting a second example method 500 of drilling a hole in a workpiece having a pilot hole formed therein using a drill jig system. In method 500, the hole is drilled from an opposite side of the workpiece from the pilot hole. Drill jig system 100 of FIG. 1 is one example of a drill jig system that can be used to perform method 500. Accordingly, the drill jig system used to perform method 500 can include a clamping device (e.g., 110), an alignment device (e.g., 120), and a drill guide device (e.g., 130), as previously described with reference to FIG. 1.

Method 500 of FIG. 5 can include the previously described operations of method 300 of FIG. 3 with the exception of operation 324 in which the drill guide device is inserted into the first opening (i.e., the same opening that received the alignment device), and operation 326 in which drilling is performed while the drill guide device is inserted into the first opening. Within method 500 of FIG. 5, operations 324 and 326 are replaced by operations 524 and 526, respectively.

At 524, method 500 can include inserting the drill guide device into the second opening formed within the other of the first clamping device or the second clamping device from the first opening to align the drilling axis of the drill guide device with the pilot hole. As an example, alignment device 120 can be received within first opening 142 of first clamp member 112, and drill guide device 130 can be received within second opening 144 of second clamp member 114. As the drill guide device and the alignment device are received by different openings, operation 524 can be performed at any suitable time, including prior to inserting the alignment device at 312, prior to positioning the first clamp member and second clamp member at 314, prior to clamping the clamping device at 320, or after removing the alignment device from the first opening.

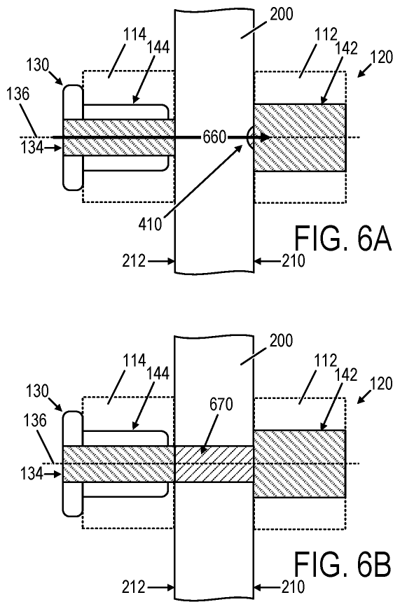

Referring to FIG. 6A, for example, first clamp member 112 and second clamp member 114 are clamped to opposing sides of workpiece 200, as previously described with reference to FIG. 4D. However, in the example of FIG. 6A, alignment device 120 has been removed from first opening 142, and drill guide device 130 has been inserted into and is received by second opening 144. Drilling axis 136 is aligned with pilot hole 410 in FIG. 6A.

In FIG. 6A, for example, drilling can be performed along drilling axis 136 through drill guide device 130, in the direction indicated by arrow 660. In this example, drilling can progress toward the side of the workpiece within which pilot hole 410 is formed (e.g., first surface 210) from the opposing side of the workpiece (e.g., second surface 212). Furthermore, in this example, first opening 142 can provide clearance for a drill bit to drill a through hole in workpiece 200.

Referring again to FIG. 5, at 526, the method can include, while the clamping device remains clamped and the drill guide device is inserted into and received by the second opening, drilling the hole in the workpiece along the drilling axis through the drill guide device. In this example, the hole can be drilled using a drill bit progressing through the workpiece toward the side of workpiece within which the pilot hole is formed from the opposing side of the workpiece.

FIG. 6B depicts a hole 670 that was drilled in workpiece 200 along drilling axis 136 through drill guide device 130. In this example, hole 670 is a through hole drilled through workpiece 200 from first side 212 to second side 210. Hole 670 can instead take the form of a blind hole that is drilled to a prescribed depth in workpiece 200 from second side 212.

According to an example of the present disclosure, a drill jig system for drilling a hole in a workpiece having a pilot hole formed therein comprises: a clamping device including a first clamp member and a second clamp member operable to clamp onto opposing sides of a workpiece; a drill guide device that defines a drilling axis; and an alignment device removably received within a first opening in the first clamp member or the second clamp member, wherein the alignment device includes a spring-biased alignment element that is biased toward the workpiece and into the pilot hole to align the drilling axis of the drill guide device with the pilot hole. In this example or other examples disclosed herein, the alignment device is a ball-spring plunger; and the alignment element takes the form of a ball of the ball-spring plunger. In this example or other examples disclosed herein, the first opening removably receives the drill guide device while the alignment device is removed from the first opening. In this example or other examples disclosed herein, another of the first clamp member or the second clamp member defines a second opening that removably receives the drill guide device. In this example or other examples disclosed herein, the spring-biased alignment element of the alignment device defines an alignment axis; and alignment axis is colinear with the drilling axis while the alignment device is received by the first opening and the drill guide device is received by the second opening. In this example or other examples disclosed herein, the clamping device further includes: one or more spanning members coupling the first clamp member and the second clamp member; wherein at least one of the one or more spanning members is an adjustable spanning member operable to vary a clamping distance between the first clamp member and the second clamp member. In this example or other examples disclosed herein, the first clamp member defines an outer profile of a first clamp surface that tapers toward a nose end of the first clamp member; wherein the first opening is formed within the first clamp member at a location that is closer to the nose end of the first clamp member than each of the one or more spanning members. In this example or other examples disclosed herein, the second clamp member defines an outer profile of a second clamp surface that tapers toward a nose end of the second clamp member; wherein the one or more spanning members align the nose end of the first clamp member with the nose end of the second clamp member. In this example or other examples disclosed herein, the drill guide device includes a drill bushing having a bore that defines the drilling axis; and wherein the bore accommodates a drill bit. In this example or other examples disclosed herein, the drill guide device is one of a plurality of drill guide devices that each include a drill bushing having a bore of a different diameter than each other drill guide device of the plurality of drill guide devices; and wherein the drill jig system comprises the plurality of drill guide devices. In this example or other examples disclosed herein, the drill jig system further comprises a locking mechanism operable to retain the alignment device within the first opening.

According to another example of the present disclosure, a method of drilling a hole in a workpiece having a pilot hole formed therein using a drill jig system comprises: positioning a first clamp member and a second clamp member of a clamping device of the drill jig system on opposing sides of the workpiece, wherein the first clamp member or the second clamp member has a first opening formed therein that removably receives an alignment device of the drill jig system, wherein the alignment device includes a spring-biased alignment element that is biased toward the workpiece and into the pilot hole; clamping the clamping device to the opposing sides of the workpiece via the first clamp member and the second clamp member while the spring-biased alignment element remains biased into the pilot hole; while the clamping device remains clamped to the opposing sides of the workpiece, removing the alignment device from the first opening and inserting a drill guide device of the drill jig system into the first opening that removably receives the drill guide device to align a drilling axis of the drill guide device with the pilot hole; and while the clamping device remains clamped to the opposing sides of the workpiece and the drill guide device is received by the first opening, drilling the hole in the workpiece along the drilling axis through the drill guide device. In this example or other examples disclosed herein, positioning the first clamp member and the second clamp member on opposing sides of the workpiece includes placing the first clamp member or the second clamp member within which the alignment device is received in contact with a surface of the workpiece having the pilot hole formed therein. In this example or other examples disclosed herein, positioning the first clamp member and the second clamp member on opposing sides of the workpiece includes moving the spring-biased alignment element along the surface of the workpiece until the spring-biased alignment element is biased into the pilot hole. In this example or other examples disclosed herein, the method further comprises forming the pilot hole in the workpiece; wherein the pilot hole takes the form of a semi-spherical divot and the alignment element takes the form of a ball.

According to another example of the present disclosure, a method of drilling a hole in a workpiece having a pilot hole formed therein using a drill jig system comprises: positioning a first clamp member and a second clamp member of a clamping device of the drill jig system on opposing sides of the workpiece, wherein the first clamp member has a first opening formed therein that removably receives an alignment device of the drill jig system that includes a spring-biased alignment element that is biased toward the workpiece and into the pilot hole, and wherein the second clamp member has a second opening formed therein that removably receives a drill guide device of the drill jig system; clamping the clamping device to the opposing sides of the workpiece via the first clamp member and the second clamp member while the spring-biased alignment element remains biased into the pilot hole; and while the clamping device remains clamped to the opposing sides of the workpiece and the drill guide device is received by the second opening, drilling the hole in the workpiece through the drill guide device along a drilling axis of the drill guide device. In this example or other examples disclosed herein, the method further comprises: while the clamping device remains clamped to the opposing sides of the workpiece and prior to drilling the hole, removing the alignment device from the first opening. In this example or other examples disclosed herein, positioning the first clamp member and the second clamp member on opposing sides of the workpiece includes placing the first clamp member in contact with a surface of the workpiece having the pilot hole formed therein. In this example or other examples disclosed herein, positioning the first clamp member and the second clamp member on opposing sides of the workpiece includes moving the spring-biased alignment element along the surface of the workpiece until the spring-biased alignment element is biased into the pilot hole. In this example or other examples disclosed herein, the method further comprises: forming the pilot hole in the workpiece; wherein the pilot hole takes the form of a semi-spherical divot and the alignment element takes the form of a ball.

It will be understood that the configurations and/or approaches described herein are exemplary in nature, and that these specific embodiments or examples are not to be considered in a limiting sense, because numerous variations are possible. The various acts illustrated and/or described as part of the methods disclosed herein may be performed in the sequence illustrated and/or described, in other sequences, in parallel, or at times omitted. Likewise, the order of the above-described operations may be changed in at least some examples.

The subject matter of the present disclosure includes all novel and non-obvious combinations and sub-combinations of the various system configurations, methods, and other features, functions, acts, and/or properties disclosed herein, as well as any and all equivalents thereof.

1. A drill jig system for drilling a hole in a workpiece having a pilot hole formed therein, the drill jig system comprising:
a clamping device including a first clamp member and a second clamp member operable to clamp onto opposing sides of a workpiece;
a drill guide device that defines a drilling axis; and
an alignment device removably received within a first opening in the first clamp member or the second clamp member, wherein the alignment device includes a spring-biased alignment element that is biased toward the workpiece and into the pilot hole to align the drilling axis of the drill guide device with the pilot hole.

2. The drill jig system of claim 1, wherein the alignment device is a ball-spring plunger; and
wherein the alignment element takes the form of a ball of the ball-spring plunger.

3. The drill jig system of claim 1, wherein the first opening removably receives the drill guide device while the alignment device is removed from the first opening.

4. The drill jig system of claim 1, wherein another of the first clamp member or the second clamp member defines a second opening that removably receives the drill guide device.

5. The drill jig system of claim 4, wherein the spring-biased alignment element of the alignment device defines an alignment axis; and
wherein the alignment axis is colinear with the drilling axis while the alignment device is received by the first opening and the drill guide device is received by the second opening.

6. The drill jig system of claim 1, wherein the clamping device further includes:
one or more spanning members coupling the first clamp member and the second clamp member;
wherein at least one of the one or more spanning members is an adjustable spanning member operable to vary a clamping distance between the first clamp member and the second clamp member.

7. The drill jig system of claim 6, wherein the first clamp member defines an outer profile of a first clamp surface that tapers toward a nose end of the first clamp member;
wherein the first opening is formed within the first clamp member at a location that is closer to the nose end of the first clamp member than each of the one or more spanning members.

8. The drill jig system of claim 7, wherein the second clamp member defines an outer profile of a second clamp surface that tapers toward a nose end of the second clamp member;
wherein the one or more spanning members align the nose end of the first clamp member with the nose end of the second clamp member.

9. The drill jig system of claim 1, wherein the drill guide device includes a drill bushing having a bore that defines the drilling axis; and
wherein the bore accommodates a drill bit.

10. The drill jig system of claim 9, wherein the drill guide device is one of a plurality of drill guide devices that each include a drill bushing having a bore of a different diameter than each other drill guide device of the plurality of drill guide devices; and
wherein the drill jig system comprises the plurality of drill guide devices.

11. The drill jig system of claim 1, further comprising a locking mechanism operable to retain the alignment device within the first opening.

12. A method of drilling a hole in a workpiece having a pilot hole formed therein using a drill jig system, the method comprising:
positioning a first clamp member and a second clamp member of a clamping device of the drill jig system on opposing sides of the workpiece, wherein the first clamp member or the second clamp member has a first opening formed therein that removably receives an alignment device of the drill jig system, wherein the alignment device includes a spring-biased alignment element that is biased toward the workpiece and into the pilot hole;
clamping the clamping device to the opposing sides of the workpiece via the first clamp member and the second clamp member while the spring-biased alignment element remains biased into the pilot hole;
while the clamping device remains clamped to the opposing sides of the workpiece, removing the alignment device from the first opening and inserting a drill guide device of the drill jig system into the first opening that removably receives the drill guide device to align a drilling axis of the drill guide device with the pilot hole; and
while the clamping device remains clamped to the opposing sides of the workpiece and the drill guide device is received by the first opening, drilling the hole in the workpiece along the drilling axis through the drill guide device.

13. The method of claim 12, wherein positioning the first clamp member and the second clamp member on opposing sides of the workpiece includes placing the first clamp member or the second clamp member within which the alignment device is received in contact with a surface of the workpiece having the pilot hole formed therein.

14. The method of claim 13, wherein positioning the first clamp member and the second clamp member on opposing sides of the workpiece includes moving the spring-biased alignment element along the surface of the workpiece until the spring-biased alignment element is biased into the pilot hole.

15. The method of claim 12, further comprising:
forming the pilot hole in the workpiece;
wherein the pilot hole takes the form of a semi-spherical divot and the alignment element takes the form of a ball.

16. A method of drilling a hole in a workpiece having a pilot hole formed therein using a drill jig system, the method comprising:
positioning a first clamp member and a second clamp member of a clamping device of the drill jig system on opposing sides of the workpiece, wherein the first clamp member has a first opening formed therein that removably receives an alignment device of the drill jig system that includes a spring-biased alignment element that is biased toward the workpiece and into the pilot hole, and wherein the second clamp member has a second opening formed therein that removably receives a drill guide device of the drill jig system;
clamping the clamping device to the opposing sides of the workpiece via the first clamp member and the second clamp member while the spring-biased alignment element remains biased into the pilot hole; and
while the clamping device remains clamped to the opposing sides of the workpiece and the drill guide device is received by the second opening, drilling the hole in the workpiece through the drill guide device along a drilling axis of the drill guide device.

17. The method of claim 16, further comprising:
while the clamping device remains clamped to the opposing sides of the workpiece and prior to drilling the hole, removing the alignment device from the first opening.

18. The method of claim 16, wherein positioning the first clamp member and the second clamp member on opposing sides of the workpiece includes placing the first clamp member in contact with a surface of the workpiece having the pilot hole formed therein.

19. The method of claim 18, wherein positioning the first clamp member and the second clamp member on opposing sides of the workpiece includes moving the spring-biased alignment element along the surface of the workpiece until the spring-biased alignment element is biased into the pilot hole.

20. The method of claim 16, further comprising:
forming the pilot hole in the workpiece;
wherein the pilot hole takes the form of a semi-spherical divot and the alignment element takes the form of a ball.
